(19) United States
(12) Patent Application Publication
(10) Pub. No.: US 2025/0117645 A1
(43) Pub. Date: Apr. 10, 2025

(54) REVERSE AUTO GENERATION OF GENERATIVE AI ENGINE PROMPTS BASED ON OUTPUT RESULTS FOR SELF-VALIDATION

(71) Applicant: Sony Interactive Entertainment Inc., Tokyo (JP)

(72) Inventor: Jin Zhang, San Mateo, CA (US)

(21) Appl. No.: 18/480,802

(22) Filed: Oct. 4, 2023

(51) Int. Cl. G06N 3/08; G06N 3/0475

(52) U.S. Cl. CPC G06N 3/08; G06N 3/0475

(57) ABSTRACT

A method for validating a generated output of a generative artificial intelligence (AI) is provided, including the following operations: receiving an input prompt through a user interface rendered by a user device; applying the input prompt to a generative AI to produce a generated output; applying the generated output to a reverse generative AI to produce a reverse-generated prompt; determining a similarity of the reverse-generated prompt to the input prompt; responsive to determining that the similarity meets or exceeds a predefined threshold, then providing the generated output for rendering through the user interface.

### BACKGROUND OF THE INVENTION

The video game industry has seen many changes over the years. As technology advances, video games continue to achieve greater immersion through sophisticated graphics, realistic sounds, engaging soundtracks, haptics, etc. Players are able to enjoy immersive gaming experiences in which they participate and engage in virtual environments, and new ways of interaction are sought. Furthermore, players may stream video of their gameplay for spectating by spectators, enabling others to share in the gameplay experience.

A video game can include many art assets which are painstakingly developed by graphic artists. The rise of generative artificial intelligence (AI) engines holds promise for speeding the process of asset development by enabling near instantaneous creation of graphical elements based on prompt information. However, generative AI can be prone to errors, which may be frustrating for users and reduce efficiency.

It is in this context that implementations of the disclosure arise.

### SUMMARY OF THE INVENTION

Implementations of the present disclosure include methods, systems and devices for reverse automatic generation of generative AI engine prompts based on output results for self-validation.

In some implementations, a method for validating a generated output of a generative artificial intelligence (AI) is provided, including the following operations: receiving an input prompt through a user interface rendered by a user device; applying the input prompt to a generative AI to produce a generated output; applying the generated output to a reverse generative AI to produce a reverse-generated prompt; determining a similarity of the reverse-generated prompt to the input prompt; responsive to determining that the similarity meets or exceeds a predefined threshold, then providing the generated output for rendering through the user interface.

In some implementations, the input prompt and reverse-generated prompt are defined by text.

In some implementations, the generated output is an image or audio.

In some implementations, the method further includes: responsive to determining that the similarity does not meet or exceed the predefined threshold, then re-applying the input prompt to the generative AI to produce a second generated output.

In some implementations, the method further includes: responsive to determining that the similarity does not meet or exceed the predefined threshold, then receiving through the user interface, edits to the input prompt, and applying the edited input prompt to the generative AI to produce a second generated output.

In some implementations, determining the similarity uses a similarity model.

In some implementations, the generative AI and the reverse generative AI are trained on substantially the same training data.

In some implementations, a method for validating a generated output of a generative artificial intelligence (AI) is provided, including the following operations: receiving an input prompt through a user interface rendered by a user device; applying the input prompt to a generative AI to produce a plurality of generated outputs; for each given generated output, applying the given generated output to a reverse generative AI to produce a reverse-generated prompt, and determining a similarity of the reverse-generated prompt to the input prompt; providing, for rendering through the user interface, ones of the generated outputs whose determined similarity meets or exceeds a predefined threshold.

In some implementations, the input prompt and reverse-generated prompt are defined by text.

In some implementations, the generated output is an image or audio.

In some implementations, the method further includes: discarding ones of the generated outputs whose determined similarity does not meet or exceed the predefined threshold.

In some implementations, determining the similarity uses a similarity model.

In some implementations, the generative AI and the reverse generative AI are trained on substantially the same training data.

In some implementations, a non-transitory computer readable medium is provided having program instructions embodied thereon that, when executed by at least one server computer, cause said at least one server computer to perform a method for validating a generated output of a generative artificial intelligence (AI), said method including: receiving an input prompt through a user interface rendered by a user device; applying the input prompt to a generative AI to produce a generated output; applying the generated output to a reverse generative AI to produce a reverse-generated prompt; determining a similarity of the reverse-generated prompt to the input prompt; responsive to determining that the similarity meets or exceeds a predefined threshold, then providing the generated output for rendering through the user interface.

Other aspects and advantages of the disclosure will become apparent from the following detailed description, taken in conjunction with the accompanying drawings, illustrating by way of example the principles of the disclosure.

### BRIEF DESCRIPTION OF DRAWINGS

The disclosure may be better understood by reference to the following description taken in conjunction with the accompanying drawings in which:

FIG. 1 conceptually illustrates a process for generating a digital item using generative AI, in accordance with implementations of the disclosure.

FIG. 2 conceptually illustrates a system for using generative AI to generate digital assets with filtering and verification to improve results, in accordance with implementations of the disclosure.

FIG. 3 conceptually illustrates a process including various possibilities for handling detected defects in generated outputs from a generative AI, in accordance with implementations of the disclosure.

FIG. 4 conceptually illustrates using user activity as feedback to refine a similarity model for validation of generative AI output, in accordance with implementations of the disclosure.

FIG. 5 conceptually illustrates a process for providing coaching to a user of a generative AI system, in accordance with implementations of the disclosure.

FIG. 6 illustrates components of an example device 600 that can be used to perform aspects of the various embodiments of the present disclosure.

### DETAILED DESCRIPTION OF THE INVENTION

Broadly speaking, implementations of the present disclosure provide systems and methods for reverse automatic generation of generative AI engine prompts based on output results for self-validation.

It will be appreciated that a generative AI is a type of artificial intelligence that is designed to create new data or content that is similar in style or format to existing data it has been trained on. Such systems are capable of generating a wide range of content, including text, images, music, and more. Many generative AI systems are based on neural networks, particularly recurrent neural networks (RNNs) or more advanced architectures like transformers. These neural networks are designed to learn patterns and relationships within the training data. During the training process, the neural network learns from the training data by adjusting its internal parameters. This process involves numerous iterations and optimization techniques to improve the model's ability to generate content. Many generative AI systems can generate content conditionally based on input data or prompts. For instance, an image generator might produce an image based on a given string of descriptive text input.

Generative AI systems can be configured to produce diverse outputs rather than repeating the same content, for example, by introducing variability through techniques such as sampling from probability distributions or by using settings to control randomness. However, evaluating the quality of generated content can be challenging. Generative AI systems may produce incorrect or nonsensical content, and require significant computational resources for training and inference in order to provide more accurate results.

In view of these problems, implementations of the present disclosure provide a system and process for validating generative AI results, by reverse-generating a prompt based on the generated output, and comparing the reverse-generated prompt to the original prompt.

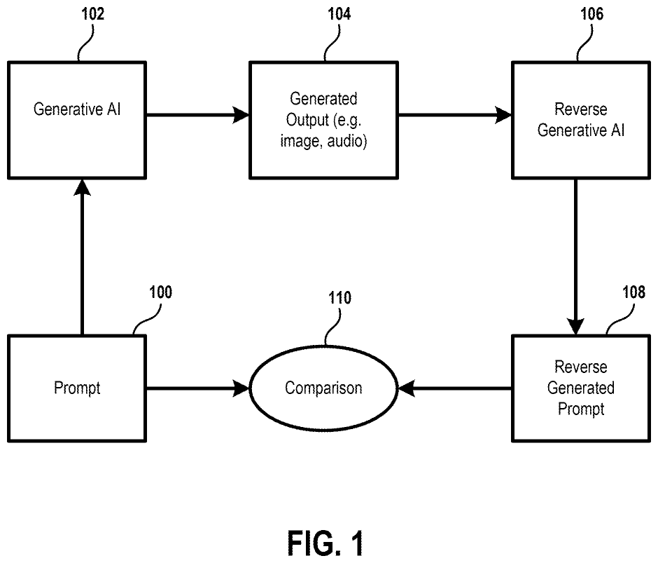

FIG. 1 conceptually illustrates a process for generating a digital item using generative AI, in accordance with implementations of the disclosure.

When a user wishes to generate a digital item using a system and process in accordance with implementations of the disclosure, the user submits a prompt 100 to a generative AI 100. By way of example without limitation, the prompt 100 can consist of text, spoken audio, images, or other types of data which can be entered by the user as input to the generative AI 100.

In response to the prompt 100, the generative AI 102 generates an output 104, such as a generated image, video, audio (e.g. music, speech, etc.), etc. The generated output 104 is then fed to a reverse generative AI 106. Broadly speaking, the reverse generative AI 108 is configured to operate in a reverse manner to the generative AI 102, accepting the generated output 104 as its input, and generating a reverse-generated prompt 108 based on the generated output 104. In other words, the reverse generative AI 106 is configured to generate a prompt (the reverse-generated prompt 108) that is descriptive of the generated output 104, and constitutes a prompt that would have been expected to produce the generated output 104 if submitted to the generative AI 102.

In some implementations, the reverse generative AI 106 is trained on substantially the same data set (training data) as the generative AI 102, but in a reverse manner. For example, if the training data consists of descriptive text and corresponding images, and the generative AI 102 is trained to generated images based on text input, then the reverse generative AI 106 is trained to generate text based on image input using substantially the same training data. In some implementations, the reverse generative AI 106 can employ the same or a similar type of AI model or machine learning model as the generative AI 102. Whereas in other implementations, the reverse generative AI 106 can employ a different type of AI model or machine learning model than that of the generative AI 102.

A comparison process 110 is performed that compares the original prompt 100 and the reverse-generated prompt 108 to determine the similarity of the prompts and whether the prompts match or are sufficiently similar, and if not, the nature of any discrepancies that exist. If the prompts match each other or are sufficiently similar, then it is likely that the generated output 104 is a suitable result based on the prompt 100. Whereas if the prompts do not match or are not sufficiently similar, then it is likely that the generated output 104 is not suitable, or is defective in some manner. It will be appreciated that by reverse generating a prompt based on the generated output 104, and comparing it against the original prompt 100, the process of the present disclosure enables validation or verification that the generated output 104 matches the user's inputted prompt. And in the case of errors made by the generative AI 102, such errors can be caught and identified before the generated output 104 would otherwise be passed on to the user. Mitigation measures can be implemented to address such errors as further discussed below. By providing improved output verification, the user's experience of using generative AI for digital item creation is improved as the user is less likely to be frustrated by poor quality results from the generative AI process.

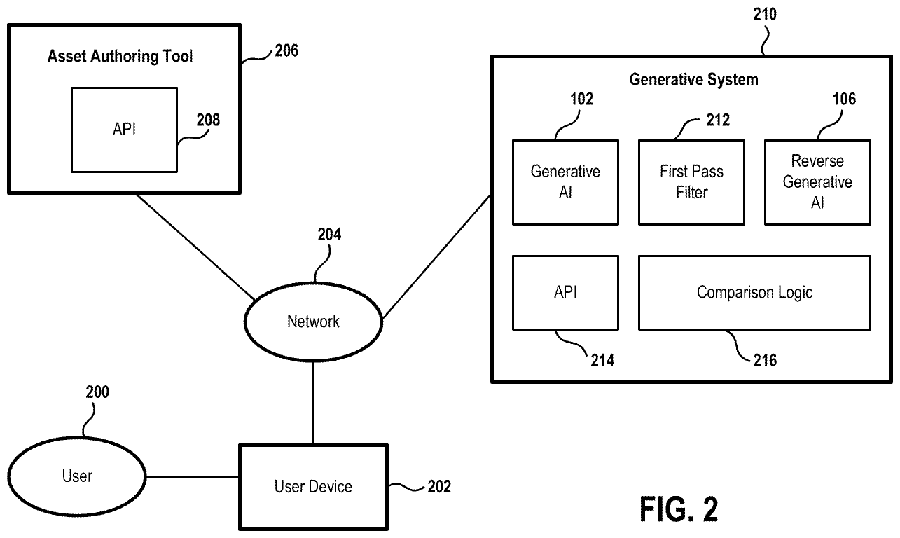

FIG. 2 conceptually illustrates a system for using generative AI to generate digital assets with filtering and verification to improve results, in accordance with implementations of the disclosure.

In the illustrated implementation, a generative system 210 is provided, which includes the aforementioned generative AI 102 and reverse generative AI 106 used to enable verification of AI-generated output as discussed above. In some implementations, the generative system 210 is used in the creation of a digital asset for use in a digital context such as a video game, website, social media app/site, etc. Accordingly, an asset authoring tool 206 is provided which can be used by a user 200 to create/edit the digital asset. In some implementations, the asset authoring tool 206 and the generative system 210 are integrated with each other, whereas in other implementations, they are separate systems.

A user 200 operates a user device 202 in order to use the asset authoring tool 206 and the generative system 210. Examples of user device 202 include a computer, laptop, mobile device, tablet, cellular phone, etc. In some implementations, the asset authoring tool 206 and/or generative system 210 are cloud applications accessed over a network 204 (which may include the Internet) by the user device 202. In some implementations, the asset authoring tool 206 and/or generative system 210 are web applications accessed over network 204 through a browser application executed by the user device 202. In other implementations, the asset authoring tool 206 and/or the generative system 210 are executed locally by the user device 202. In some implementations, the generative system 210 exposes an API 214 which can be accessed to invoke functionality of the generative system 210. In some implementations, the asset authoring tool 206 exposes an API 208 which can be accessed to invoke functionality of the asset authoring tool 206.

In some implementations, the generative system 210 operates as a plug-in to the asset authoring tool 206, so that the functionality of the generative system 210 is available through an interface of the asset authoring tool 206. In other implementations, the opposite configuration is contemplated, such that the asset authoring tool 206 functions as a plug-in to the generative system 210, so that functionality of the asset authoring tool 206 is available through an interface of the generative system 210.

Consideration of an example process for authoring an asset will be useful for demonstrating principles of the present disclosure. Suppose that the user 200 operating user device 202 wishes to create a digital asset, such as an art asset for a video game. The user 200 may open the asset authoring tool 206, and initiate creation of a digital item by the generative system 210 (e.g. by accessing the generative system 210 as a plug-in or as integrated with the asset authoring tool 206). For example, this can entail supplying a prompt to the generative system 210, such as via the API 214, and the prompt is fed to the generative AI 102 to generate one or more outputs, such as one or more generated images.

The generated output(s) are processed through a first pass filter 212, which is configured to provide rough filtering of AI-generated output to filter out obvious defects. That is, if the first pass filter 212 identifies the output as defective in some manner, then that output is discarded. In some implementations, discarding the output triggers a redo by the generative AI 102 to generate a new output, that will also be subject to the first pass filter 212. In other implementations, wherein the generative AI 102 generates multiple outputs in a single generative processing instance, then the defective output is eliminated from consideration. If all of the multiple outputs are eliminated, then this may trigger a redo by the generative AI 102 to generate a new set of outputs.

As noted, the first pass filter 212 is configured to provide basic filtering of obvious defects in the generated output. For example, in some implementations, the first pass filter 212 is configured to filter out any objectionable or obscene content. In some implementations, the first pass filter 212 is configured to check for certain generic componentry in the output matching the input prompt. For example, if the prompt specifies a person drinking coffee, then the first pass filter 212 may check that a human is indeed present in the output, but not necessarily whether the person is engaged in drinking specifically.

For a generated output that is not discarded by the first pass filter 212, then the generated output is fed to the reverse generative AI 106, as discussed above, to generate a reverse-generated prompt. A comparison logic 216 implements the comparison process 110 to compare the reverse-generated prompt with the original prompt and determine the extent of their similarity. In some implementations, this can include determining whether the reverse-generated prompt sufficiently matches the original prompt, or is sufficiently similar to the original prompt (e.g. degree of similarity meeting or exceeding a predefined threshold) to determine that the generated output is suitable as an output generated in response to the original prompt. And if so, then the generated output is returned by the generative system 210 in some implementations. In the case where there are multiple generated outputs under consideration, then the generated output with the highest degree of similarity of its reverse-generated prompt to the original prompt is returned in some implementations. In other implementations, all generated outputs with a suitable degree of similarity (of reverse-generated prompt to original prompt) are returned, so that the user 200 may select one of them for use, such as for performing further editing using the asset authoring tool 206.

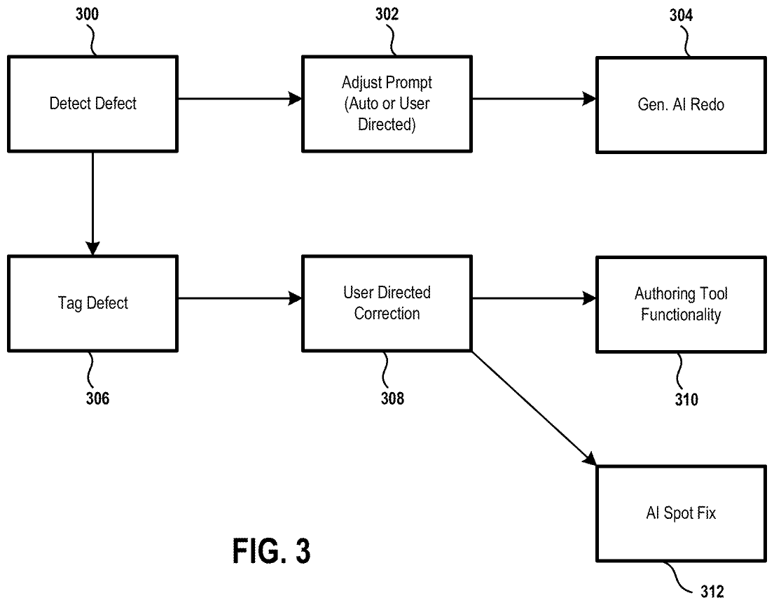

FIG. 3 conceptually illustrates a process including various possibilities for handling detected defects in generated outputs from a generative AI, in accordance with implementations of the disclosure.

At method operation 300, a defect in a generated output from the generative AI 102 is detected. For example, as discussed in accordance with implementations of the disclosure, the generated output may fail validation based on comparison of a reverse-generated prompt versus the original prompt as being too dissimilar or otherwise inconsistent. Furthermore, in some implementations, the system may identify the specific nature of the defect, such as determining what portion of the generated output does not match or is not consistent with the original prompt.

Accordingly, in some implementations, then at method operation 302, the original prompt is adjusted in a manner so as to avoid production of the defect. In some implementations, this is performed automatically, such that the system identifies the specific defect, and automatically generates additional information for inclusion in the prompt so as to prevent the defect. For example, if based on the validation process, it is determined that the generated output includes a feature that is not consistent with the original prompt, then the prompt may be automatically adjusted to include an instruction explicitly prohibiting generation of that feature. Or if based on the validation process, it is determined that the generated output omits a feature that is important or necessary to fulfill the original prompt, then the prompt may be automatically adjusted to include an explicit instruction to generate that feature.

In some implementations at method operation 302, instead of or in addition to automatic adjustment of the prompt, the user is invited to adjust the prompt, such as by surfacing an interface for editing the prompt. The user can be notified of what defect (or potential defect or inconsistency) has been detected by the system through the validation process, and thus the user can manually edit the prompt so as to avoid the defect if desired.

At method operation 304, the adjusted prompt is then submitted to the generative AI 102 in order to redo the generation and generate an output that does not include the identified defect. It will be appreciated that this process can be repeated if additional defects are found.

In some implementations, when the generated output fails validation and the defect is identified, then the defect is tagged by the system at method operation 306 and presented to the user. For example, in the case of a generated image having a given defect, then the portion of the image exhibiting the defect can be identified, and the generated image can be presented to the user with the defective portion identified, such as by describing the defective portion or visually identifying it (e.g. using arrows/pointers, demarcation lines identifying defective portion, highlighting, etc.). At method operation 308, the user can then direct the performance of an action to correct the defect. For example, in some implementations, the user may utilize a functionality 310 of the authoring tool to correct the defect (e.g. an image editing tool). Or in some implementations, the user may use the generative AI itself (ref. 312), but in a targeted manner to correct the defect. That is, the generative AI can be applied to the particular defective portion of the generated output, so as to adjust or regenerate the portion in accordance with instructions provided by the user.

In various implementations, the operations and concepts discussed herein can be combined in various ways to provide a process to enable better results from generative AI. For example, when a generated output fails validation, in some implementations, the generation process and validation are repeated until an output passes validation. In some implementations, when the generation process is repeated, the prompt is optionally adjusted or changed, either automatically by the system or manually by the user. In some implementations, the generation process and validation are repeated up to a predefined maximum number of times (e.g. once, twice, three times, etc.), after which, if the generated result still fails validation, then the defect is tagged or the user is otherwise notified of the defect, and the user is presented with options to fix the defect, such as by manually editing the prompt, or editing the generated output itself, such as by using an authoring tool or generative AI.

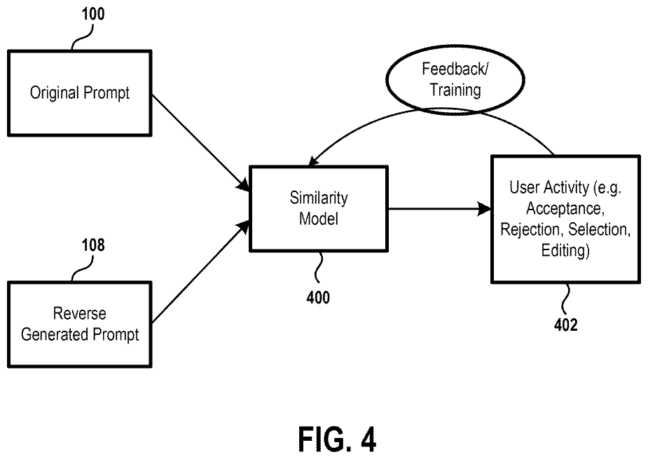

FIG. 4 conceptually illustrates using user activity as feedback to refine a similarity model for validation of generative AI output, in accordance with implementations of the disclosure.

As has been discussed, in accordance with implementations of the disclosure, a generated output of a generative AI is validated by reverse generating a prompt, and comparing the reverse-generated prompt 108 against the original prompt 100. In some implementations, the aforementioned comparison logic 216 applies a similarity model 400 to determine the similarity of the reverse-generated prompt 108 and the original prompt 100. It will be appreciated that the similarity model 400 can be a type of machine learning model that is configured to evaluate the similarity of the prompts. In some implementations, the similarity model 400 employs natural language processing techniques in the case where the prompts consist of language content.

It will be appreciated that in the context of the present disclosure, determining the “similarity” of prompts can be related, but not necessarily equivalent to similarity as defined for other purposes. For example, in the case of text prompts, similarity of the original text prompt and the reverse-generated text prompt as applied herein is defined by the extent to which they are correlated or functionally equivalent to each other in a way that confirms the acceptability of the generated output as reflecting the original prompt. Thus, the similarity model 400 as presently described may be related to techniques used for natural language processing and the like, but is not necessarily tuned for lexicographic or conventional semantic similarity. Rather, the similarity model 400 is tuned to determine “similarity” of the reverse-generated prompt as an indicator of the suitability of the generated output for the original prompt.

In some implementations, in order to further refine the similarity model 400 over time, the user's activity 402 with respect to any generated output of the generative AI can be applied as feedback or used to further train the similarity model 400. In this manner, the similarity model 400 can be improved over time in its ability to accurately determine the similarity of the reverse-generated prompt to the original prompt for purposes of validating the generated output in terms of its consistency with the original prompt.

For example, when the user is presented with a generated output, the user may accept the generated output, or reject it (and possibly request a new generated output), or further edit the generated output, etc. Such actions can be indicative of the user's sentiment or opinion regarding the generated output and to what extent the generated output meets the user's expectations. Thus, such activity is useful as feedback for further training the similarity model 400.

For example, if for a given generated output, the similarity model 400 validated the reverse-generated prompt as sufficiently similar to the original prompt, but the user rejects the generated output, then this may be indicative that the reverse-generated prompt was not actually sufficiently similar to the original prompt, and thus the similarity model 400 can be trained on the reverse-generated prompt and the original prompt in this instance as an example of insufficient similarity. In some implementations, if the user further edits the generated output, this may indicate a specific way in which the reverse-generated prompt was insufficiently similar to the original prompt, and this information can be used to refine the similarity model 400 accordingly. For example, the user's edits may be directed to a specific portion of the generated output, and accordingly, a corresponding portion of the reverse-generated prompt and/or corresponding portion of the original prompt can be identified and used as an example of prompt information that is not sufficiently similar.

In some implementations, if the user is given multiple possible generated outputs to choose from, then the user's selection can be indicative of which of the possible generated outputs has a reverse-generated prompt that is most similar to the original prompt amongst the group. Thus, this information can be used to train the similarity model 400.

In some implementations, a training mode is implemented wherein generated outputs of the generative AI are presented to the user without being screened for validation, and the user activity with respect to the generated outputs is tracked. For example, the user might perform activity such as select a given generated output, further edit a selected generated output, adjust their input prompt, instruct the generative AI to redo the generation, etc. It will be appreciated that that the user activity is indicative of the suitability of the generated outputs. Reverse-generated prompts for the various generated outputs are generated, and the user activity is therefore used to train the similarity model 400 regarding the similarity of the reverse-generated prompts to corresponding original prompts.

Thus, the training mode can be activated when the user wishes to improve the quality of the validation process provided by the system.

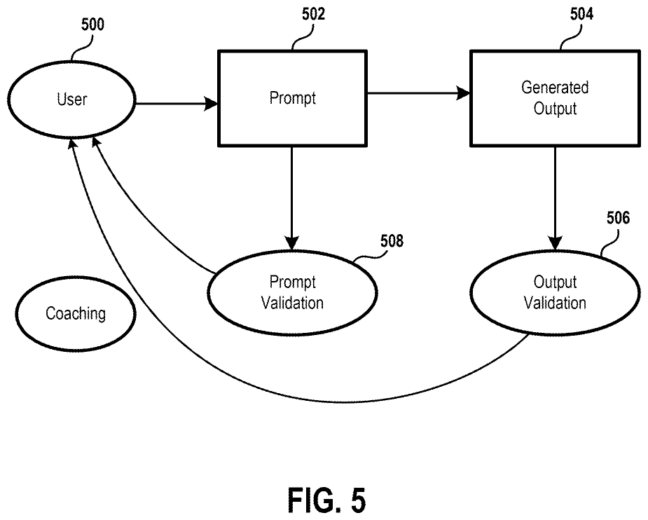

FIG. 5 conceptually illustrates a process for providing coaching to a user of a generative AI system, in accordance with implementations of the disclosure.

In the illustrated implementation, a user 500 inputs a prompt 502 to the generative AI system, and the generative AI generates an output 504, as has been discussed. An output validation process 506 can be performed in accordance with the principles described above. In some implementations, the result of the output validation process 506 is used to provide coaching to the user 500, for example, through a user interface of the generative AI system with which the user interacts. For example, the results of the output validation may indicate a portion of the generated output 504 that is potentially defective, and accordingly, the user may be coached or notified to adjust their prompt so as to address the potential defect. In some implementations, such coaching may identify a portion of the prompt to be adjusted so as to affect the relevant portion of the generated output.

In some implementations, the results of performing the output validation process 506 can be used to define a prompt validation process 508 capable of evaluating prompts prior to being used by the generative AI. More specifically, the prompt validation process 508 is configured to evaluate a prompt inputted by a user to determine recommended adjustments which should be made to the prompt to improve the reliability of the generated output when the final prompt is applied to the generative AI. It will be appreciated that the prompt validation process 508 can include a machine learning model trained on input prompts and their output validation process 506 results, which indicate for various kinds of prompts the resulting quality of the generated outputs from such prompts. In this manner, the prompt validation process 508 can determine the likelihood of a given inputted prompt to provide a high quality result, and provide coaching recommendations regarding how to improve the prompt to achieve a better result. For example, after the user 500 enters the prompt 502 through a user interface, the prompt validation process 508 can be performed, and coaching or recommendations for how to improve the prompt can be surfaced through the user interface. The new adjusted prompt can then be fed to the generative AI to produce a generated output 504 that is more likely to be satisfactory to the user 500.

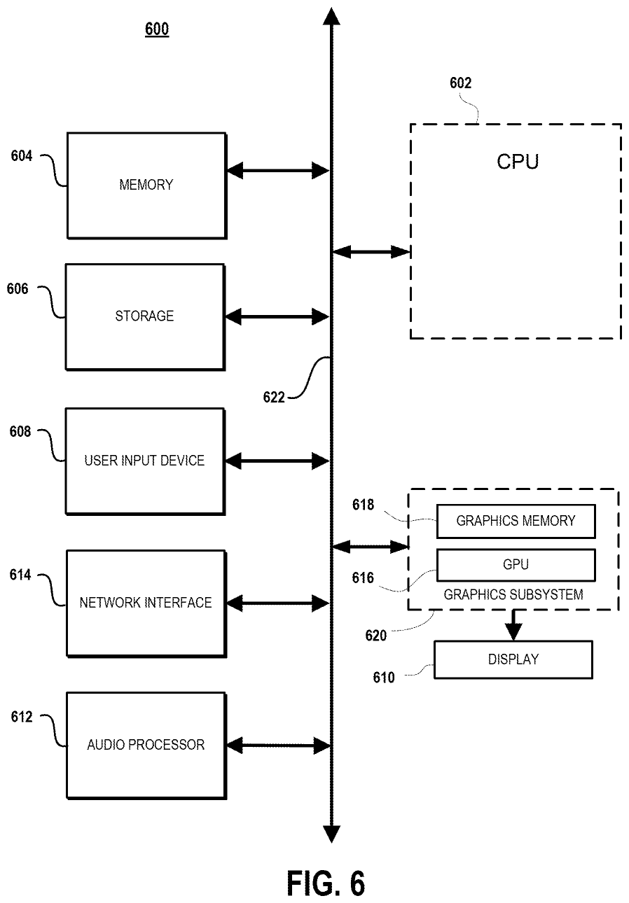

FIG. 6 illustrates components of an example device 600 that can be used to perform aspects of the various embodiments of the present disclosure. This block diagram illustrates a device 600 that can incorporate or can be a personal computer, video game console, personal digital assistant, a server or other digital device, suitable for practicing an embodiment of the disclosure. Device 600 includes a central processing unit (CPU) 602 for running software applications and optionally an operating system. CPU 602 may be comprised of one or more homogeneous or heterogeneous processing cores. For example, CPU 602 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 600 may be a localized to a player playing a game segment (e.g., game console), or remote from the player (e.g., back-end server processor), or one of many servers using virtualization in a game cloud system for remote streaming of gameplay to clients.

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600, including CPU 602, memory 604, data storage 606, user input devices 608, network interface 610, and audio processor 612 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Graphics memory 618 can be integrated in the same device as GPU 608, connected as a separate device with GPU 616, and/or implemented within memory 604. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs.

The graphics subsystem 614 periodically outputs pixel data for an image from graphics memory 618 to be displayed on display device 610. Display device 610 can be any device capable of displaying visual information in response to a signal from the device 600, including CRT, LCD, plasma, and OLED displays. Device 600 can provide the display device 610 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud- based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method for validating a generated output of a generative artificial intelligence (AI), comprising:
receiving an input prompt through a user interface rendered by a user device;
applying the input prompt to a generative AI to produce a generated output;
applying the generated output to a reverse generative AI to produce a reverse-generated prompt;
determining a similarity of the reverse-generated prompt to the input prompt;
responsive to determining that the similarity meets or exceeds a predefined threshold, then providing the generated output for rendering through the user interface.

2. The method of claim 1, wherein the input prompt and reverse-generated prompt are defined by text.

3. The method of claim 1, wherein the generated output is an image or audio.

4. The method of claim 1, further comprising:
responsive to determining that the similarity does not meet or exceed the predefined threshold, then re-applying the input prompt to the generative AI to produce a second generated output.

5. The method of claim 1, further comprising:
responsive to determining that the similarity does not meet or exceed the predefined threshold, then receiving through the user interface, edits to the input prompt, and applying the edited input prompt to the generative AI to produce a second generated output.

6. The method of claim 1, wherein determining the similarity uses a similarity model.

7. The method of claim 1, wherein the generative AI and the reverse generative AI are trained on substantially the same training data.

8. A method for validating a generated output of a generative artificial intelligence (AI), comprising:
receiving an input prompt through a user interface rendered by a user device;
applying the input prompt to a generative AI to produce a plurality of generated outputs;
for each given generated output, applying the given generated output to a reverse generative AI to produce a reverse-generated prompt, and determining a similarity of the reverse-generated prompt to the input prompt;
providing, for rendering through the user interface, ones of the generated outputs whose determined similarity meets or exceeds a predefined threshold.

9. The method of claim 8, wherein the input prompt and reverse-generated prompt are defined by text.

10. The method of claim 8, wherein the generated output is an image or audio.

11. The method of claim 8, further comprising:
discarding ones of the generated outputs whose determined similarity does not meet or exceed the predefined threshold.

12. The method of claim 8, wherein determining the similarity uses a similarity model.

13. The method of claim 8, wherein the generative AI and the reverse generative AI are trained on substantially the same training data.

14. A non-transitory computer readable medium having program instructions embodied thereon that, when executed by at least one server computer, cause said at least one server computer to perform a method for validating a generated output of a generative artificial intelligence (AI), said method comprising:
receiving an input prompt through a user interface rendered by a user device;
applying the input prompt to a generative AI to produce a generated output;
applying the generated output to a reverse generative AI to produce a reverse-generated prompt;
determining a similarity of the reverse-generated prompt to the input prompt;
responsive to determining that the similarity meets or exceeds a predefined threshold, then providing the generated output for rendering through the user interface.

15. The non-transitory computer readable medium of claim 14, wherein the input prompt and reverse-generated prompt are defined by text.

16. The non-transitory computer readable medium of claim 14, wherein the generated output is an image or audio.

17. The non-transitory computer readable medium of claim 14, further comprising:
responsive to determining that the similarity does not meet or exceed the predefined threshold, then re-applying the input prompt to the generative AI to produce a second generated output.

18. The non-transitory computer readable medium of claim 14, wherein the method further comprising:
responsive to determining that the similarity does not meet or exceed the predefined threshold, then receiving through the user interface, edits to the input prompt, and applying the edited input prompt to the generative AI to produce a second generated output.

19. The non-transitory computer readable medium of claim 14, wherein determining the similarity uses a similarity model.

20. The non-transitory computer readable medium of claim 14, wherein the generative AI and the reverse generative AI are trained on substantially the same training data.
